(19) United States
(12) Patent Application Publication
(10) Pub. No.: US 2006/0041208 A1
(43) Pub. Date: Feb. 23, 2006

(54) Impact type massager

(76) Inventor: Shan-Chi Ko, Hualien County (TW)

Correspondence Address: BACON & THOMAS, PLLC, 625 SLATERS LANE, FOURTH FLOOR, ALEXANDRIA, VA, 22314, US

(21) Appl. No.: 11/204,013

(22) Filed: Aug. 16, 2005

(30) Foreign Application Priority Data
Aug. 20, 2004 (TW) 93213371

(51) Int. Cl. A61H 1/00

(52) U.S. Cl. 601/15; 601/97; 601/107

(57) ABSTRACT

A massager is disclosed to include a first receiving barrel has a barrel body, a massage head formed at front end of the barrel body, a receiving hole formed inside the barrel body, a deposit portion formed inside the massage head, and a stricken part mounted on the deposit portion, the stricken part being impacted and providing releasing of ions; an impact part has a first hitting portion movably installed inside the receiving hole of the first receiving barrel for hitting the stricken part of the first receiving barrel and release the stricken part.

### BACKGROUND OF THE INVENTION

1. Field of the Invention

The present invention relates to massagers and more particularly, to a massager with impacting functions.

2. Description of the Related Art

Conventional massager usually has a bar used to press human body for achieve releasing pains and other functions. Further, for more functions, the operator will take another ion generation device nearby the massager, therefore the user must held the massager at one hand and the ion generation device at another hand, therefore cause diffcault to operating; Moreover, the distance of ion generation device will variable by user's hand and causing the ions cannot have a good distance applied to human body. And the ion generation device must conduct an electric power, the user cannot use in the place without power supply.

### SUMMARY OF THE INVENTION

The present invention has been accomplished under the circumstances in view. It is the main object of the present invention to provide a massager, which combines ion releasing means and massager, the ions can be released during operation of the massager. It is another object of the present invention to provide a massager, which has a simple structure that is easy to install and to operate. It is still another object of the present invention to provide a massager, which generate the ions by shake and impact but not electric power, convenient to use in any place.

To achieve these and other objects of the present invention, the massager comprising: a first receiving barrel having a barrel body, a massage head formed at front end of the barrel body, a receiving hole formed inside the barrel body, a deposit portion formed inside the massage head, and a stricken part mounted on the deposit portion, the stricken part being impacted and providing releasing of ions; an impact part having a first hitting portion movably installed inside the receiving hole of the first receiving barrel for hitting the stricken part of the first receiving barrel and release the stricken part.

### BRIEF DESCRIPTION OF THE DRAWINGS

FIG. 1 is a sectional assembly view of a massager according to the present invention.

FIG. 2 is a sectional exploded view of the massager according to the present invention.

FIG. 3 is a schematic drawing showing the operation status of the massager according to the present invention.

FIG. 4 is a sectional assembly view of another embodiment of a massager according to the present invention.

FIG. 5 is a sectional assembly view of still another embodiment of a massager according to the present invention.

FIG. 6 is a sectional assembly view of still another embodiment of a massager according to the present invention.

### DETAILED DESCRIPTION OF THE INVENTION

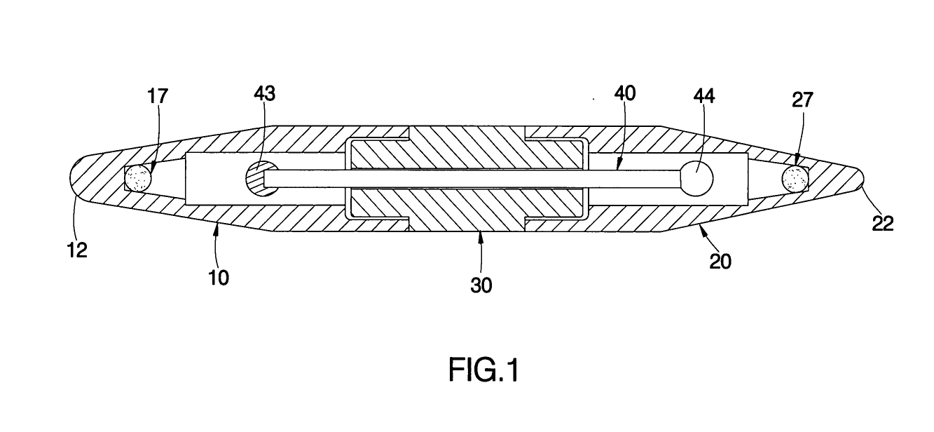

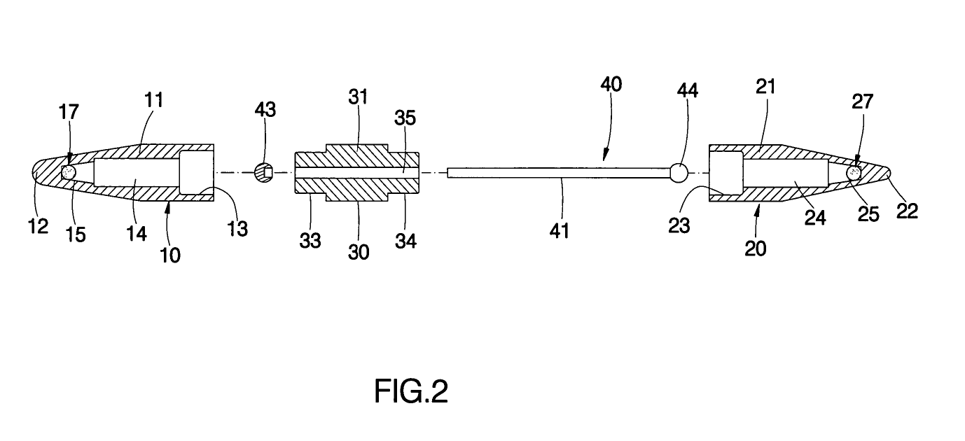

Referring to FIG. 1 and FIG. 2, a massager of a preferred embodiment of the present invention comprises:

A first receiving barrel 10 has a barrel body 11 of cylinder shape, a massage head 12 formed at front end of the barrel body 11, a connect portion 13, a receiving hole 14 formed inside the barrel body 11, a deposit portion 15 formed inside the massage head 12, and a stricken part 17 mounted on the deposit portion 15, the stricken part 17 being impacted and providing releasing of ions.

A second receiving barrel 20 has a barrel body 21 of cylinder shape, a massage head 22 formed at front end of the barrel body 21, a connect portion 23, a receiving hole 24 formed inside the barrel body 21, a deposit portion 25 formed inside the massage head 22, and a stricken part 27 mounted on the deposit portion 25, the stricken part 27 being impacted and providing releasing of ions.

Wherein the outer diameter of the massage head 12 of the first receiving barrel 10 is bigger than the outer diameter of the massage head 22 of the second receiving barrel 20, the material of massage head 12 and massage head 22 can be metal or strengthen plastic, and the first receiving barrel 10 and second receiving barrel 20 composed a receiving barrel set.

A connecting bush 30 has a bush body 31 of hollow cylinder shape, two barrel connecting portion 33 and 34 formed at each end of the bush body 31 for connecting the first receiving barrel 10 and second receiving barrel 20 respectively, and a sliding fitting hole 35.

An impact part 40 has an axle 41 slidably inserted in the sliding fitting hole 35 of the connecting bush 30, a first hitting portion 43 and a second hitting portion 44 of round head shape connected at each end of the axle 41 for hitting the stricken part 17 of the first receiving barrel 10 and stricken part 27 of the second receiving barrel 20 respectively.

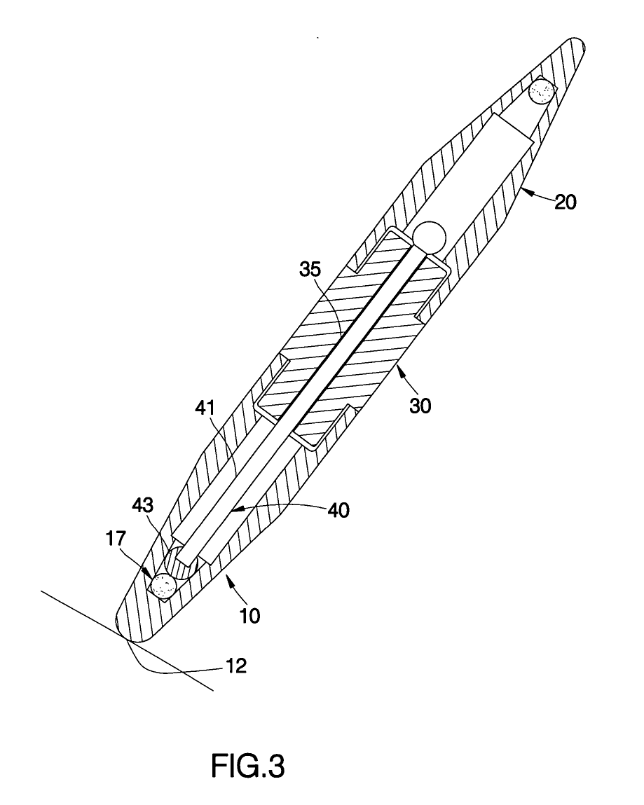

Referring to FIG. 3, using one hand to hold the massager and chose the first receiving barrel 10 or second receiving barrel 20 to operate, that is massage head 12 or massage head 22 is used to contact the skin of human; shake the massager up and down slightly to let the impact part 40 moving up and down, the first hitting portion 43 and second hitting portion 44 then impact the stricken part 17 or stricken part 27 at the lower side, the stricken part 17 or stricken part 27 then release ions toward the contacted area of the massage head 12 or massage head 22.

Therefore, the massager of the present invention is convenient to use to massage human body, and easy to operate to generating ions and releasing to the contacted area of massage, the structure is simple and easy to operate.

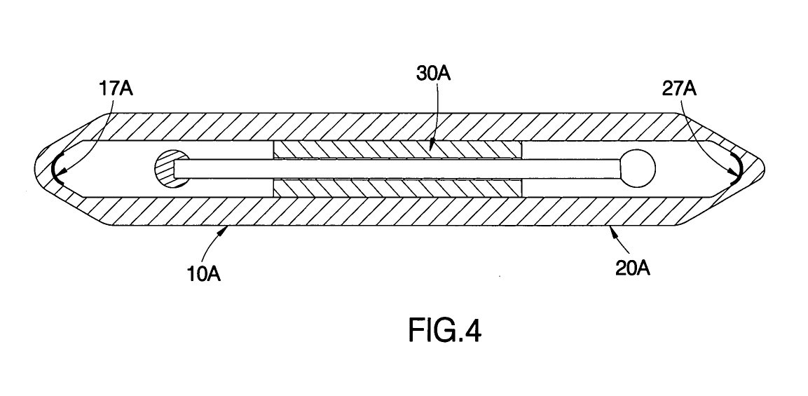

Referring to FIG. 4, an alternate form of the present invention as shown, wherein the first receiving barrel 10A and second receiving barrel 20A are formed integrated (or can be assembled together to form a part), and the connecting bush 30 is inserted inside the receiving holes of the first receiving barrel 10A and second receiving barrel 20A, and the stricken parts 17 and 27 are formed an arch thin layer and made by powder molding.

Further, the connecting bush of the massager of aforesaid embodiments can be cancelled, or the axle of the impact part still can be cancelled but still achieve movement of the impact part.

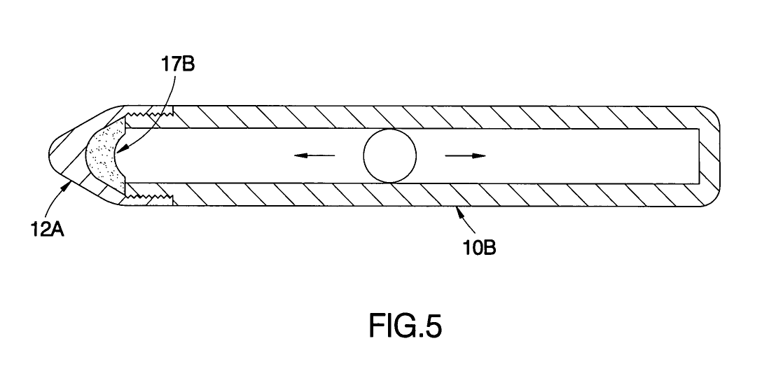

Referring to FIG. 5, an alternate form of the present invention as shown, wherein one of the first receiving barrel or second receiving barrel can be cancelled, such as the massager comprises first receiving barrel 10B but not second receiving barrel, the massager still covered the objective and functions of the present invention. The massage head 12A of the first receiving barrel 10B is an individual part and threaded to the first receiving barrel 10B, the stricken part 17B is jointly assembled between the first receiving barrel 10B and massage head 12A.

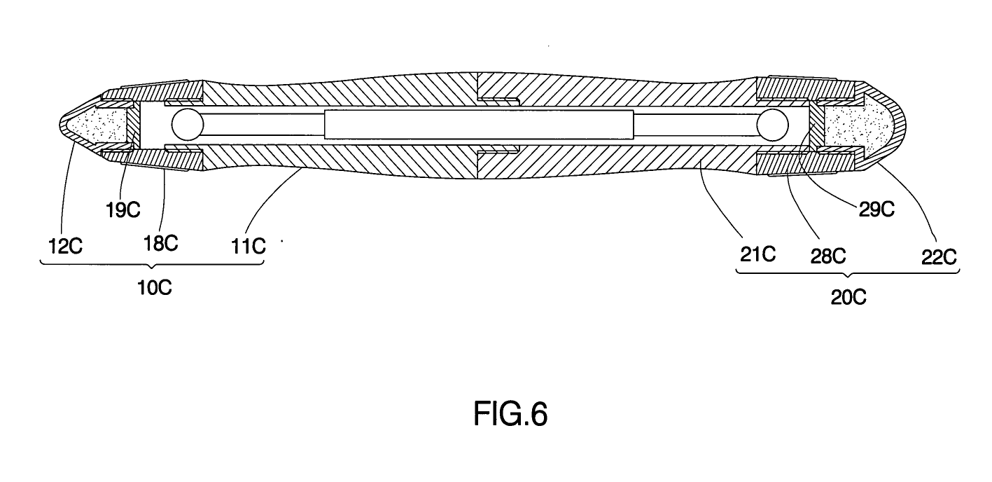

Referring to FIG. 6, an alternate form of the present invention as shown, wherein the first receiving barrel 10C is composed of a barrel body 11C, a massage head 12C and a connecting neck 18C, the second receiving barrel 20C is composed of a barrel body 21C, a massage head 22C and a connecting neck 28C also, the first receiving barrel 10C and second receiving barrel 20C each further has an isolating cover 19C and 29C for covering each stricken part respectively and being struck by said impact part.

Further, the stricken part of the first receiving barrel and second receiving barrel can be a plurality of fungus which being impacted to release to human body.

As indicated above, the invention provides a massager, which has the following advantages:

1. The massager combines ion releasing means and massager, the ions can be released during operation of the massager.

2. The massager has a simple structure that is easy to install and to operate.

3. The massager generate the ions by shake and impact but not electric power, convenient to use in any place.

What is claimed is:

1. A massager comprising:
a first receiving barrel having a barrel body, a massage head formed at front end of said barrel body, a receiving hole formed inside said barrel body, a deposit portion formed inside said massage head, and a stricken part mounted on said deposit portion, said stricken part being impacted and providing releasing of ions;
an impact part having a first hitting portion movably installed inside said receiving hole of said first receiving barrel for hitting said stricken part of said first receiving barrel and release said stricken part.

2. The massager as claimed in claim 1, further comprises a connecting bush connected to said first receiving barrel, said connecting bush has a sliding fitting hole, said impact part has an axle slidably inserted to said sliding fitting hole of the connecting bush.

3. The massager as claimed in claim 1, further comprises a second receiving barrel connected to said first receiving barrel.

4. The massager as claimed in claim 1, wherein said first receiving barrel further has an isolating cover for covering said stricken part of the first receiving barrel and stricken by said impact part.

5. The massager as claimed in claim 1, wherein said stricken part of said first receiving barrel provides releasing of ion or fungus.
